(19) United States
(12) Patent Application Publication
(10) Pub. No.: US 2006/0170706 A1
(43) Pub. Date: Aug. 3, 2006

(54) Systems and methods for rendering three-dimensional graphics in a multi-node rendering system

(76) Inventors: Donley Byron Hoffman, Fort Collins, CO (US); Jeffrey Joel Walls, Fort Collins, CO (US); Byron Alan Alcorn, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/048,192

(22) Filed: Feb. 1, 2005

(51) Int. Cl. G09G 5/00

(52) U.S. Cl. 345/629

(57) ABSTRACT

A system is provided for rendering three-dimensional graphics. The system comprises a host capable of executing an application program that calls for the rendering of three-dimensional graphics in an application window and a plurality of render nodes configured to collectively render a three-dimensional graphics image in response to graphics input supplied by the host. The system further comprises logic associated with the host for generating a plurality of graphics windows that collectively comprise the application window, wherein the graphics windows comprise at least one three-dimensional graphics window and at least one two-dimensional graphics window, and logic associated with the host for communicating to the plurality of render nodes information associated with only the at least one three-dimensional graphics window.

### BACKGROUND OF THE INVENTION

The rendering of three-dimensional computer graphics is a computationally intensive process. In many high-end applications, three-dimensional computer graphics are rendered using a pool or cluster of computers, which share the processing responsibilities. In such a system, one computer may be configured to execute at least one application program and communicate graphics data to other computers for rendering. In this regard, a collection of computers may be configured to cooperatively render a graphics image and may receive the graphics data to be rendered from the computer executing the application program.

When multiple computers are used to render a single scene or image, the video signals generated by each of those computers are combined into a single aggregate (or composite) signal and encoded in a particular format, such as NTSC (National Television Standards Committee), PAL (phase alteration by line), etc. There exist devices called compositors that perform the function of combining (or compositing) multiple video signals into a single, composite video signal. Accordingly, there are known approaches for performing the functions of a compositor.

In operation, a host or master computer is configured to execute an application program, which generates three-dimensional graphics for presentation to a user. Program control, two-dimensional graphics and windows, user interface functions, and other aspects may be performed on the master or host computer. Three-dimensional graphics-rendering operations, however, are performed by a plurality (or cluster) of slave or render nodes. In such a system, a significant amount of data and other information is communicated from the host or master computer to the render nodes for rendering. As graphics scenes change, windows are moved or resized, or content within the windows is changed, additional communications occur between the host computer and the various render nodes in order to communicate changed information to the render nodes for rendering.

The three-dimensional graphics information is generally communicated to all render nodes, providing each render node with state and other information on the other render nodes. This, however, consumes excessive bandwidth in the communication of information to all render nodes, as well as consumes excessive memory and processing resources at each render node.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagram illustrating certain components in a system constructed in accordance with an embodiment of the invention.

FIG. 2 is a diagram illustrating a screen-space allocation of a four-node render cluster of a system constructed in accordance with an embodiment of the invention.

FIGS. 3A, 3B, and 3C are diagrams that illustrate a hierarchical windowing structure, and reduction, implemented in accordance with an embodiment of the invention.

FIG. 4 is a diagram illustrating certain logic components that are implemented on a host computer and render nodes of an embodiment of the present invention.

FIGS. 5A, 5B, and 5C illustrate the impact of an exemplary window resize operation, in a display screen, partitioned into four quadrants.

FIGS. 6A, 6B, and 6C are diagrams illustrating operations that take place at a host node and render nodes of a system, constructed in accordance with an embodiment of the invention, corresponding to the windowing operations illustrated in FIGS. 5A, 5B, and 5C.

FIG. 7 is a flowchart illustrating the top-level functional operation of an embodiment of the present invention.

### DETAILED DESCRIPTION

Accordingly, there is a desire for systems and methods that provide more efficient three-dimensional graphics rendering.

It should be understood that the embodiments described herein are presented to illustrate certain concepts and features of embodiments of the invention, and the scope and spirit of the present invention should not be construed as limited to only the embodiments described. The term “window” as used herein should be construed in a generic fashion. The term “window” is not intended to be associated with or limited to a screen area that is created or presented under the Microsoft Windows operating system. Indeed, as should be appreciated from the description herein, the concepts and teachings of the present invention are applicable to windowing environments in general. Such environments could include a Microsoft Windows environment, an X (sometimes referred to as a X Windows) Unix-based system, or other windowing systems.

Further, the embodiments described herein use the terms “application window” and “graphics window.” The term “application window” refers to a rectangular area that is created or defined by an application program running on a host computer. In contrast, the term “graphics window” refers to a sub-window of an application window. In this regard, an application window generally consists of a plurality of graphics windows, which plurality of windows include both two-dimensional and three-dimensional graphics windows. Indeed, in the X windowing environment, even the simplest application widows may comprise a number of graphics windows. It is common for an application window to comprise many user interface components (e.g., menus, widgets, decorations, dialogs, and so on) with only a small number of three-dimensional windows.

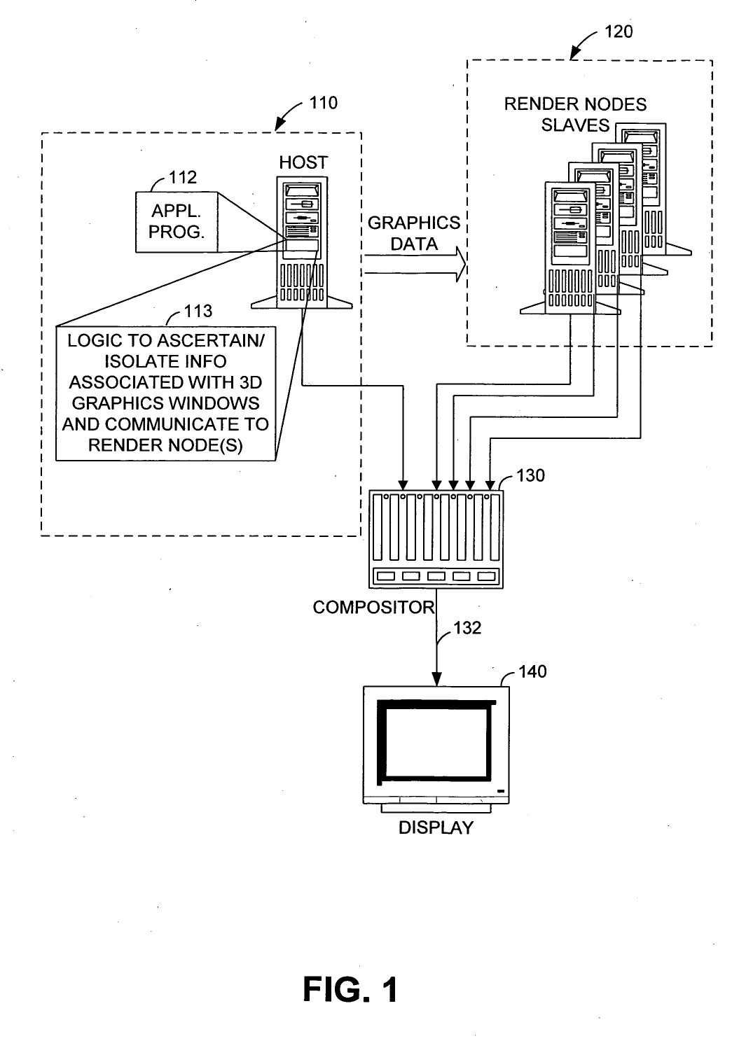

With this brief introduction to certain terms that will be used herein, reference is now made to the drawings, in which FIG. 1 illustrates a computing environment in which one embodiment of the present invention resides and operates. Many high-end or intensive graphic programs are executed, and graphics images are rendered, using a plurality of computers in combination. There are various ways in which multiple computers are configured to operate either in parallel or in conjunction to perform a graphics-rendering task. One way is to configure one computer 110 to operate as a master (or host), and configure the remaining plurality of computers 120 to operate as slaves (or render nodes). In the illustrated embodiment, the slave computers 120 are configured to collectively render a three-dimensional graphics image. The rendering among the slave computers 120 is partitioned or allocated in a variety of ways. One way is to partition the screen space into various partitions and have each slave computer render the data associated with its partition. Another way is to partition the graphics data into layers and have each slave 120 render one or more layers.

In the embodiment illustrated in FIG. 1, the master computer 110 executes an application program 112 that involves the rendering of three-dimensional graphics. The control and functionality of the application program 112 is handled by the master computer 110. As well, the master computer 110 handles various two dimensional graphics rendering that is incidental to the execution of the application program 112. For example, the presentation of drop-down menus or other items of presentation that do not require three-dimensional rendering is performed by the master computer 110. Each of the computers (master computer 110 and each of the slave computers 120) comprises a graphics card (or other graphics circuitry) that outputs a signal for a video display 140. Since, however, the content that is rendered by each of the computers must first be combined, the video outputs of each of the computers are delivered to a compositor 130. A compositor 130 operates to combine the content of each of the plurality of input video signals to deliver a single, composite output signal 132 that is used to drive a display device 140.

Consistent with the scope and spirit of the embodiments described herein, an alternative environment comprises multiple displays 140 that are configured to operate as a single logical display. There are a variety of applications in which graphics information is presented over a panel or matrix of displays, to effectively emulate a single, large display. Examples of such systems include: real estate, financial (such as the stock market), control room, large engineering processes, military mapping, telecommunications, etc. Such systems require the output of large amounts of data, which can easily exceed the viewable display capacity of a single, physical monitor (a user could view relevant data only by panning and zooming).

In a system environment such as that of FIG. 1, the computer 110 executing the graphics application program communicates to the cluster of render nodes 120 the relevant data utilized for carrying out the rendering operations. The structure and content of such data will be known and appreciated by persons skilled in the art, as it is the underlying data specifying primitives, texture, lighting, shading, and other aspects employed for rendering a given graphics image. In one embodiment, such information is communicated by the master 110 to the individual slave computers as appropriate, based upon the partitioned operation of the slave units.

In accordance with an embodiment of the present invention, the host 110 comprises logic 113 for ascertaining and/or isolating information associated with three-dimensional graphics windows and communicating that information to the render nodes. In one embodiment, the three-dimensional graphics information is communicated only to the relevant render nodes (i.e., the render nodes responsible for rendering the portion of the display to which the three-dimensional graphics information pertains). In other embodiments, the three-dimensional graphics information in communicated to all render nodes, so that each render node has relevant information about the other render nodes.

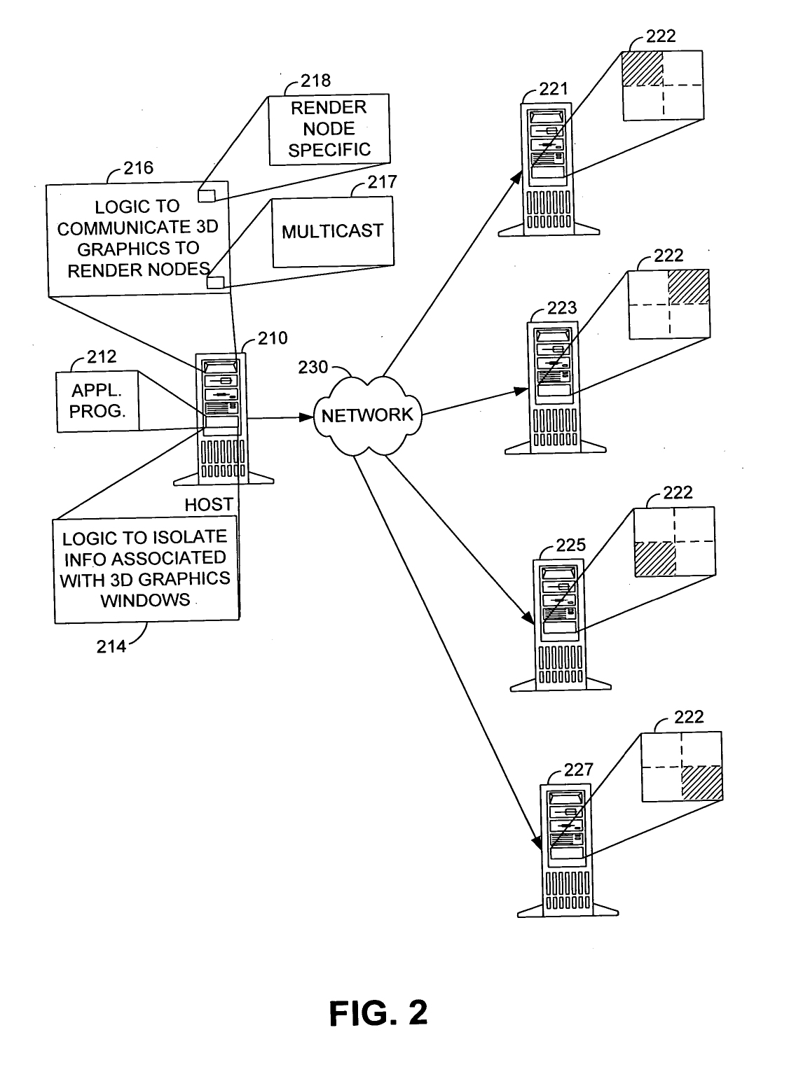

Reference is now made to FIG. 2, which is a diagram illustrating certain aspects of an embodiment of the present invention. Specifically, FIG. 2 illustrates features pertaining to the host and render nodes, and the compositor and display components have been omitted from this figure for simplicity. In the embodiment illustrated in FIG. 2, a host node 210 is configured to execute an application program 212 that calls for the rendering of three-dimensional graphics. For purposes of illustration herein, consider an application program such as a CAD (computer-aided design) modeling program, that enables a user to design, model, and/or display three-dimensional figures. In addition to the three-dimensional figures or models that may be represented on the display, such an application program also presents to a user menus and other items in 2-D, which do not require three-dimensional rendering.

The embodiment illustrated in FIG. 2 utilizes four render nodes 221, 223, 225, and 227. Of course, consistent with the scope and spirit of the invention, additional or fewer render nodes maybe utilized. Further, each render node is allocated or assigned a specific portion of the display 140, such that the graphics image to be rendered is subdivided in screen space and allocated to each of the respective render nodes. In the illustration provided in FIG. 2, render node 221 is allocated (indicated by shading) the upper left quadrant of the display (virtual display represented by reference number 222), render node 223 is allocated the upper right quadrant of the display, render node 225 is allocated the lower left quadrant of the display, and render node 227 is allocated the lower right quadrant of the display.

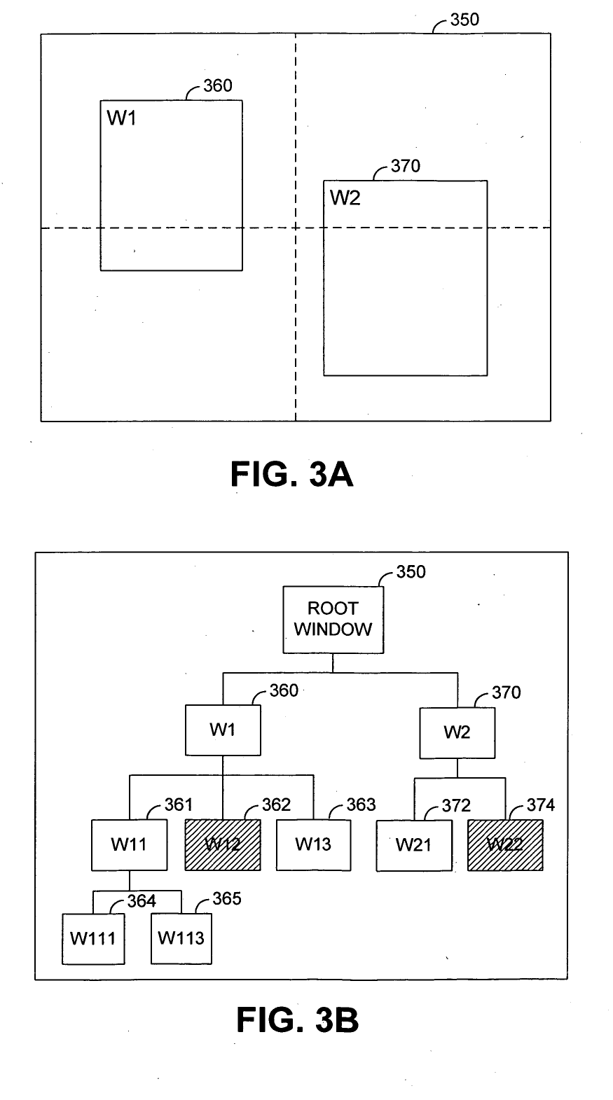

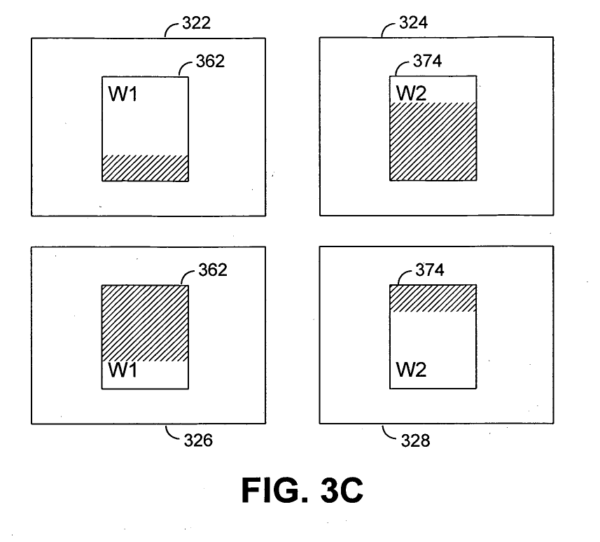

The host node 210 further comprises logic 214 for identifying and isolating information associated with three-dimensional graphics windows. This “information” comprises information necessary for rendering the content of the three-dimensional graphics window, as well as information defining the size and placement of the three-dimensional graphics window on the display. The manner in which this logic 214 operates, in accordance with one embodiment, is further described in connection with FIG. 3. In addition, the host node 210 comprises logic 216 for communicating the information associated with the three-dimensional graphics windows to the render nodes. In one embodiment, the logic 216 includes logic 218 for mapping the information onto the specific and relevant render nodes and communicating the information to only the render nodes that require the information for performing their rendering operation in the particular quadrant or portion of the display screen allocated to the respective render nodes. In another embodiment, this information may be communicated to all render nodes using, for example, a multicast messaging protocol 217.

As a brief illustration, consider the execution of the application program 212, such that it generates only one three-dimensional graphics window, and further that that three-dimensional graphics window implicates only the top central portion of the display screen. In such an embodiment, only render nodes 221 and 223 are implicated, as render nodes 225 and 227 are responsible for rendering the lower half of the display screen. Therefore, in such a scenario, after the logic 214 identifies and isolates the relevant information for rendering the three-dimensional graphics window, logic 216 communicates that information to render nodes 221 and 223 for rendering. It can be readily appreciated that such an embodiment minimizes unnecessary communications over the network 230 (e.g., no communications to render nodes 225 and 227), and further minimizes unnecessary resource consumption of the various render nodes by providing each render node with only the information needed for its effective operation.

Reference is now made to FIGS. 3A, 3B, and 3C, which are diagrams that provide an illustration of a hierarchical windowing structure utilized by an embodiment to the present invention to effectively organize and isolate two-dimensional and three-dimensional graphics windows. FIG. 3A illustrates an exemplary display 350 for a computer executing an application program that presents two application windows 360 and 370 to a user. Dashed lines are shown bisecting the display 350 both vertically and horizontally, to designate the screen-space allocation of the four exemplary render nodes. As shown, in the illustration, application window 360 spans portions of the upper left and lower left quadrants of the display 350, while application window 370 spans portions of the upper and lower right hand quadrants of the display 350.

FIG. 3B illustrates a hierarchical window tree that partitions each of the application windows 360 and 370 into their constituent two-dimensional and three-dimensional graphics windows components. A hierarchical window tree, such as that presented in 3B, is generated and maintained at the host node. A root window 350 corresponds to the area of the display. Beneath the root window 350 are sub-windows 360 and 370, which correspond to the application windows presented on the display. Below each application window are the constituent two-dimensional and three-dimensional graphics windows. In the example presented in FIG. 3B, there is a layer of three graphics windows 361, 362, and 363 that comprise the application window 360. In the illustration, graphics windows 361 and 363 are two-dimensional windows, while graphics window 362 (shaded) is a three-dimensional graphics window. Further, due to nesting or other reasons, graphics window 361 is further comprised of subwindows 364 and 365, which are both two-dimensional graphics windows in this illustration. Likewise, application window 370 is illustrated as comprising only two subwindows, which are a two-dimensional graphics window 372 and a three-dimensional graphics window 374. It should be appreciated that the depiction of FIG. 3B is greatly simplified for purposes of illustration herein. As mentioned above, typical application windows comprise a much larger number of sub-component graphics windows (e.g., some comprising as many as several hundred graphics windows). In graphics systems of the prior art, such an entire hierarchical windowing structure is communicated to each and every one of the various render nodes, so that each render node can maintain state information for the entire system. In contrast, and resulting in significant savings of bandwidth and computing resources, an embodiment of the present invention communicates only information associated with three-dimensional graphics windows to the various implicated render nodes. One beneficial aspect relates to the extraction of the relevant information to communicate to the render nodes—and when to communicate it—to keep the pipeline moving smoothly and accurately according to what is represented on the master node. In this regard, the relevant information comprises information needed by a particular render node for rendering its assigned portion of the three-dimensional graphics window. Advantageously, each render node need not be communicated state or other information relevant to other render nodes. Further, with regard to when the information is communicated, such communications take place in response to content or configuration changes that are detected by the host.

FIG. 3C is a diagram illustrating the information that is communicated to the various render nodes, in accordance with an embodiment of the invention. In this regard, as illustrated in FIG. 2, a system having four render nodes is configured such that each render node is responsible for a quadrant of the display area. Reference numbers 322, 324, 326, and 328 are used in FIG. 3C to illustrate the information that is allocated or communicated to the respective render nodes.

Referring to the hierarchical tree of FIG. 3B, graphics window 362 is designated as a three-dimensional graphics window (which is a sub-window of the application window 360). Therefore, the information associated with this window is communicated to the relevant render nodes. With reference to FIG. 3A, the two render nodes that are affected by graphics window 362 are the render nodes responsible for rendering the upper and lower left hand quadrants of the display. Therefore, display areas 322 and 326 (and the corresponding render nodes) receive information relating to graphics window 362. In one embodiment, the content and information associated with graphics window 362 may be entirely communicated to each of the corresponding render nodes. In another embodiment, however, the information associated with graphics window 362 is partially communicated to the render node associated with display area 322 and partially communicated to the render node associated with the display area 326. As illustrated in FIG. 3C, the shaded portions of the windows 362, in display areas 322 and 326, represent the portion of the window 362 that is not needed or utilized by the respective render node for that display area and the unshaded portion represents the portion of the window that is utilized in that associated render node. Likewise, the information associated with graphics windows 374 (corresponding to application window 374 of FIG. 3B) is communicated to render nodes associated with display areas of 324 and 328. In one embodiment, the entirety of the information maybe communicated to both of the render nodes, while in another embodiment only the information relevant to each respective render node is communicated to that node.

Again, it should be appreciated that the embodiments described herein result in substantial performance increases by substantially reducing bandwidth and system resources required of previous implementations.

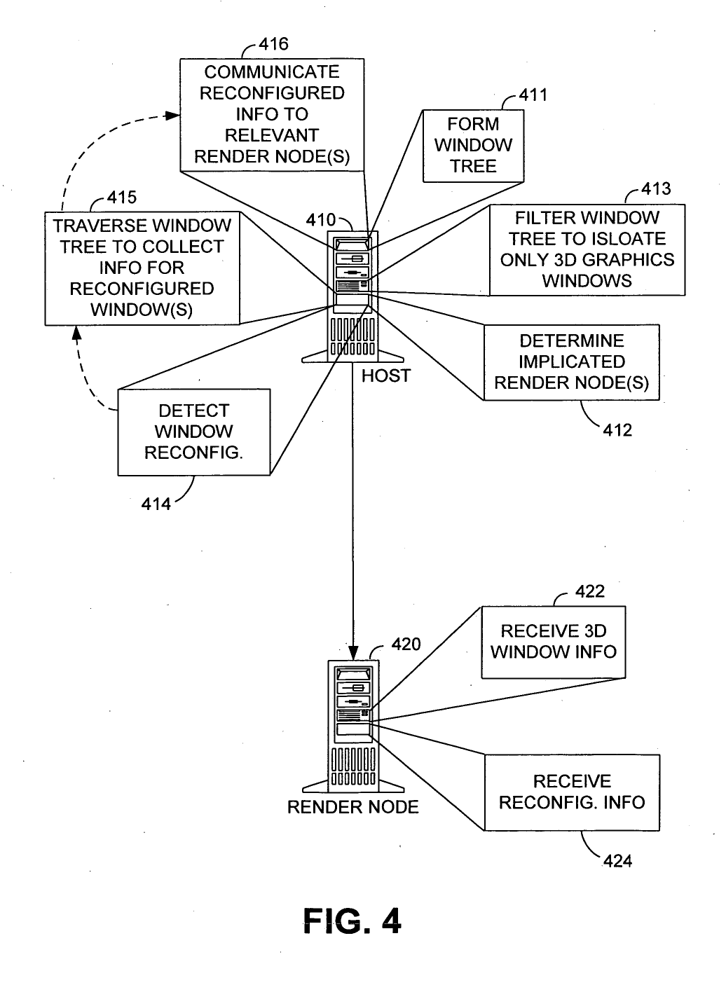

Reference is now made to FIG. 4, which is a diagram illustrating certain components of an embodiment of the present invention. Principle features of the embodiment reside on host 410. In this regard, host 410 comprises logic 411 configured to form a window tree. As illustrated in FIG. 3, the window tree is preferably a hierarchical tree that isolates all sub-windows that comprise the application window(s) to be presented on a display. It should be appreciated that the relevant information could be organized in ways other than a hierarchical window tree, but such a window tree has been used in X windowing systems, and is known. Thus, in the context of various embodiments of invention, the windows may be stored in a variety of ways, so long as the host can determine how the windows are “stacked” (i.e., positioned on the display relative to other windows that may obscure a given window), and how windows are “parented” (i.e., whether three-dimensional windows have three-dimensional children, or sub-windows).

The host 410 further comprises logic 412 to determine which render nodes are implicated by the various graphics windows contained within the window tree. In turn, logic 413 filters the window tree to identify and/or isolate the three-dimensional graphics windows, and further to communicate the associated information of these windows to the relevant or implicated render nodes. It should be appreciated that this alone provides significant performance enhancements of the embodiment over systems known in the prior art. In addition, however, the illustrated embodiment provides additional performance-enhancing features. For example, logic 414 is provided to detect certain window reconfigurations, such as a window move or a window resizing operation; for example, a user clicks on an application window with a mouse to drag the window to another location of the screen, or resize the window. The resizing of such an application window, also results in a resizing of the corresponding three-dimensional graphics window(s). In such situations, where the three-dimensional graphics content has already been processed and rendered, a move or resize operation may be implemented without requiring the render nodes to re-render the entire window.

Instead, a simple BLT (block level transfer) may be performed within the frame buffer or other area of the render nodes to affect a window move operation. Accordingly, logic 415 is provided on the host 410 to traverse the hierarchical tree to collect or revise relevant information for such reconfigured windows. Logic 416 is provided to communicate the relevant information for specifying the reconfiguration to the relevant render nodes. Of course, if an application window is rendered completely in the upper right quadrant of a display, such that it implicates render node 223 (of the embodiment of FIG. 2), and a user then moves that window into the upper left quadrant of the display, then the implicated render node will become render node 221. In one embodiment, the relevant information may be communicated to render node 221, from the host computer, such that render node 221 performs a re-rendering operation of the graphics content. In another embodiment, the previously rendered content maybe communicated from render node 223 to render node 221, thereby saving render node 221 processing resources associated with the rendering process, as well as graphics-level resources (e.g., texture memory).

Corresponding to the logic components illustrated on host 410, render nodes 420 (only one shown in FIG. 4) comprise logic 422 for receiving information associated with a three-dimensional graphics window. In ways that are known, this information may then be used by the render node for rendering the graphics information to a display area. In addition, the render node 420 comprises logic 421 for receiving reconfiguration information that is communicated from the host 410. This reconfiguration information is utilized by the render node 420 to resize or move previously rendered graphics information within the allocated display area.

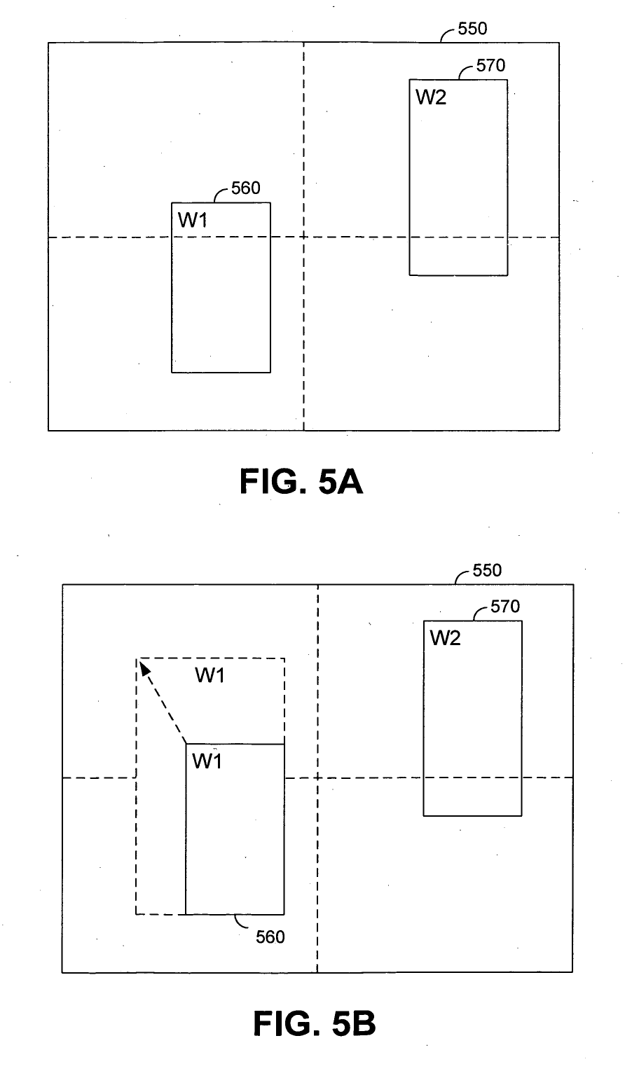

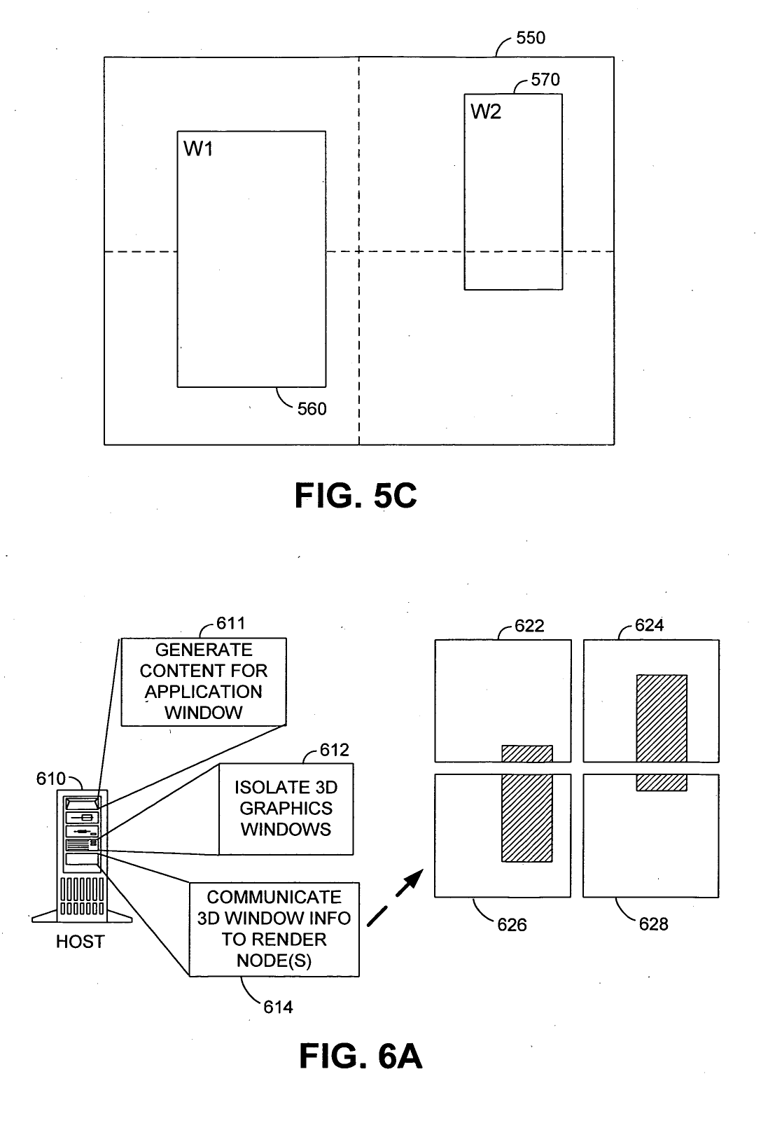

Reference is now made to FIGS. 5A, 5B, and 5C, which illustrate the display of two application windows 560 and 570 within a display area 550 at a given time, FIG. 5A shows an application window 560 that spans the upper and lower left hand quadrants of the display 550. Likewise, a second application window 570 spans the upper and lower quadrants of the right hand side of the display 550. FIG. 5B illustrates a resizing operation of the application window 560 such that it is expanded in size. FIG. 5C, shows the resulting, resized windows 560 and 570.

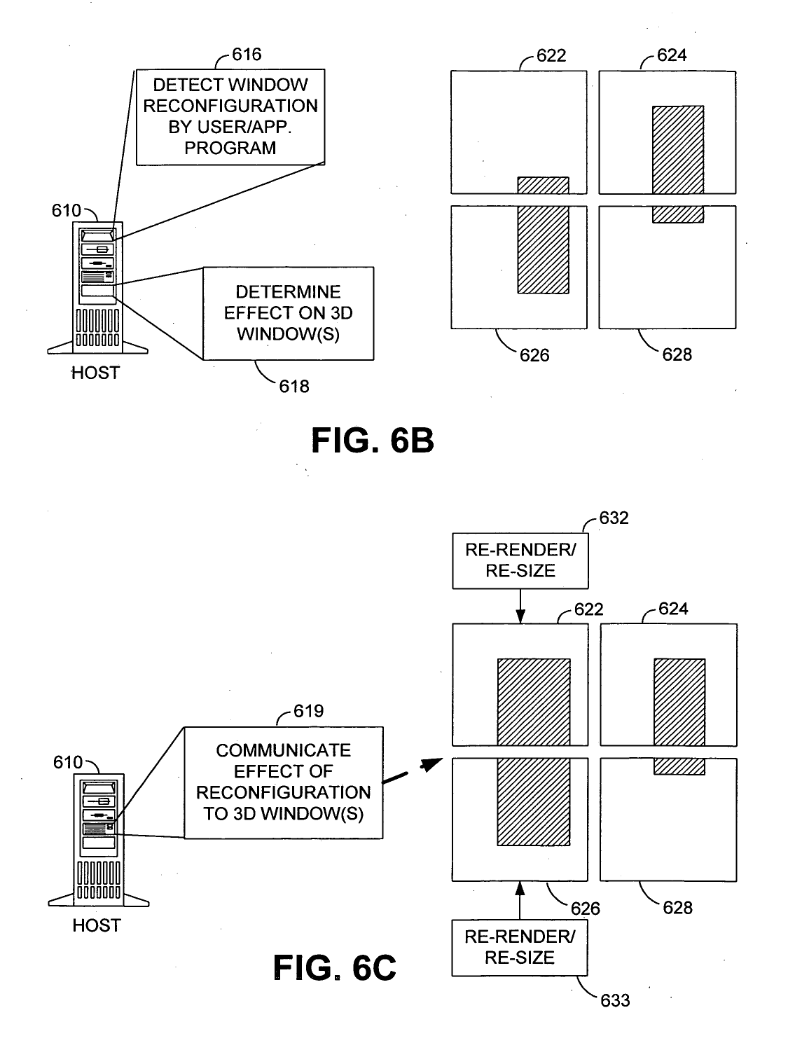

Reference is now made to FIG. 6A, 6B, and 6C which illustrate resulting operations that take place on the host 610. First, the host, through the execution of an application program, generates content for the application windows (611). Thereafter, the host isolates 3-D graphics windows that are sub-components of the application windows (612). In one embodiment, this isolating of the three graphics windows may be implemented through the utilization of an OpenGL library interface, which, by monitoring calls to the OpenGL library, can determine that an application wants to use a window for three-dimensional rendering. This detection of a three-dimensional window causes the creation of a process or thread to monitor the three-dimensional window on the master node for changes (using the hierarchical window tree, or other window organization).

Thereafter, the host 610 communicates 614 the relevant information for the three-dimensional graphics windows to the corresponding render nodes. Display areas 622, 624, 626, and 628, illustrate the portions of the three-dimensional graphics windows that each is responsible for rendering. In this illustration, for simplicity, the three-dimensional graphics windows are illustrated as comprising effectively the entire size or dimension of the application windows 560 and 570. As illustrated in FIG. 6B, as a user or application program causes a window to be reconfigured, the host 610 detects the reconfiguration (616). Thereafter, the host determines the effect of the reconfiguration on the three-dimensional windows (618). Finally, as illustrated in FIG. 6C the host 610 communicates the information relevant to the reconfiguration of the application windows and the relevant three-dimensional graphics windows to the appropriate render nodes (619). As illustrated by reference numerals 632 and 633, the resize/reconfiguration operation illustrated in FIGS. 5A-5C results in a re-rendering or re-scaling of the windows within display areas 622 and 626. Significantly, there is no change to the information rendered in display areas 624 and 628, and therefore no additional processing is required of the render nodes corresponding to those display areas. With regard to the render nodes responsible for rendering the display areas 622 and 626, it should be appreciated that the particular reconfiguration illustrated in FIG. 5B, does not require any additional content information to be communicated to the render node responsible for display area 626. It does, however, require additional content to be communicated to the render node responsible for display area 622. This information could be communicated from the host computer 610, or alternatively could be communicated directly from the render node responsible for rendering area 626.

In this regard, content information is information generated by an application program that defines a three-dimensional graphics image to be rendered. Therefore, in the embodiment described above, when a window is reconfigured such that at least a portion of the graphics window expands or moves from a display area serviced by one render node into a display area serviced by another window node, then the display of that reconfigured window could be handled in either of a couple of ways. In one embodiment, the host could recommunicate the content information to the render node having the additional window area to be displayed, and that render node could re-render its portion of the graphics window. In an alternative embodiment, the rendered information could be communicated directly between the impacted render nodes.

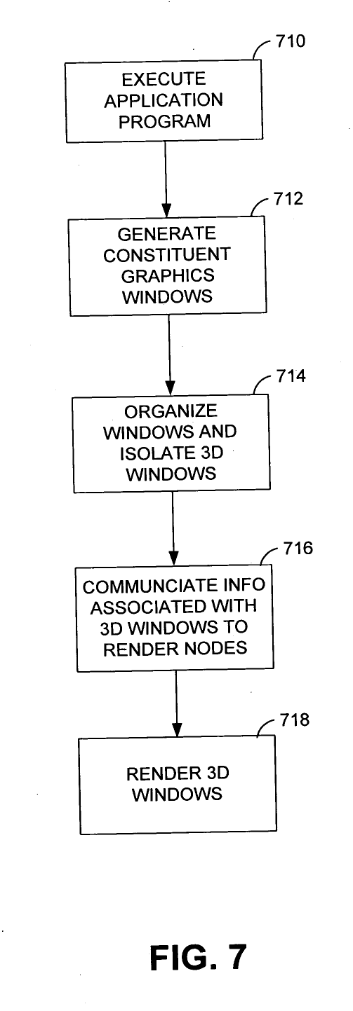

Reference is now made to FIG. 7, which is a flow chart illustrating the top-level functional operation of an embodiment of the invention. In accordance with the illustrated embodiment, an application program is executed on a host node that calls for the rendering of three-dimensional graphics in one or more application windows (710). The method then generates, on the host node, a plurality of constituent graphics windows that collectively comprise the application window (712). As described herein, these constituent windows comprise both two-dimensional and three-dimensional graphics windows and are designated or identified as such. Further, the constituent windows are organized such that three-dimensional windows, or windows that impact three-dimensional rendering operations, can be readily identified (714). Thereafter, the information associated with the three-dimensional windows is communicated from the host to the relevant, implicated render nodes for rendering (716). Finally, the information that is communicated to the render nodes is utilized by the render nodes to collectively render the three-dimensional graphics window(s) (718).

1. A system for rendering three-dimensional graphics comprising:
a host capable of executing an application program that calls for the rendering of at least three-dimensional graphics in an application window;
a plurality of render nodes configured to collectively render a three-dimensional graphics image in response to graphics input supplied by the host;
logic associated with the host for generating a plurality of graphics windows that collectively comprise the application window, wherein the graphics windows comprise at least one three-dimensional graphics window and at least one two-dimensional graphics window; and
logic associated with the host for communicating to the plurality of render nodes information associated with only the at least one three-dimensional graphics window.

2. The system of claim 1, further comprising a compositor configured to receive outputs from the host and each of the plurality of render nodes, the compositor configured to generate a composite output signal for a display.

3. The system of claim 1, wherein the logic for generating a plurality of graphics windows is configured to organize the plurality of graphics windows in a hierarchical structure.

4. The system of claim 1, further comprising logic for detecting a configuration change in the at least one three-dimensional graphics windows.

5. The system of claim 4, wherein the configuration change comprises an operation selected from the group consisting of re-sizing of a graphics window and moving of a graphics window.

6. The system of claim 1, wherein the logic for communicating is specifically configured to communicate configuration information to the plurality of render nodes, in response to the detection of a configuration change, without re-communicating the content information.

7. The system of claim 4, wherein the logic for communicating is more specifically configured to communicate to the plurality of render nodes only information sufficient to identify the change associated with the at least one three-dimensional graphics window.

8. The system of claim 1, further comprising logic associated with the host for mapping a three-dimensional graphics window to implicated render nodes.

9. The system of claim 8, wherein the logic for communicating is specifically configured to communicate graphics information of the at least one three-dimensional graphics window only to the implicated render nodes.

10. In a three-dimensional graphics rendering system, a method comprising:
executing, on a host node, an application program that calls for the rendering of at least three-dimensional graphics in an application window;
generating, on the host node, a plurality of graphics windows that collectively comprise the application window, wherein the graphics windows comprise at least one three-dimensional graphics window and at least one two-dimensional graphics window;
communicating from the host node to a plurality of render nodes information associated with only the at least one three-dimensional graphics window; and
collectively rendering, by the plurality of render nodes, a three-dimensional graphics image in response to information communicated from the host.

11. The method of claim 10, further comprising generating a single composite signal from the host and each of the plurality of render nodes, the compositor configured to generate a composite output signal for a display.

12. The method of claim 10, further comprising organizing, on the host, the plurality of graphics windows in a hierarchical structure.

13. The method of claim 10, further comprising detecting a configuration change in the at least one three-dimensional graphics windows.

14. The method of claim 13, wherein the communicating is specifically configured to communicate configuration information to the plurality of render nodes, in response to the detection of a configuration change, without re-communicating the content information.

15. The system of claim 10, wherein the communicating is specifically configured to communicate graphics information of the at least one three-dimensional graphics window only to implicated render nodes.

16. A system for rendering three-dimensional graphics comprising:
a host capable of executing an application program that calls for the rendering of at least three-dimensional graphics in an application window;
a plurality of render nodes configured to collectively render a three-dimensional graphics image;
logic associated with the host for generating a plurality of graphics windows that collectively comprise the application window, wherein the graphics windows comprise at least one three-dimensional graphics window and at least one two-dimensional graphics window; and
logic associated with the host for communicating to the plurality of render nodes information for rendering the at least one three-dimensional graphics window, without communicating information for non three-dimensional graphics windows to the plurality of render nodes.

17. The system of claim 16, further comprising logic for detecting a configuration change in the at least one three-dimensional graphics window, after content information has been communicated to the plurality of render nodes.

18. The system of claim 17, wherein the logic for communicating is specifically configured to communicate configuration information to the plurality of render nodes, in response to the detection of a configuration change, without re-communicating the content information to the plurality of render nodes.

19. (canceled)

20. A system for rendering three-dimensional graphics comprising:
means for executing an application program that calls for the rendering of at least three-dimensional graphics in an application window;
means for rendering a three-dimensional graphics image in response to graphics input supplied by the means for executing;
means for generating a plurality of graphics windows that collectively comprise the application window, wherein the graphics windows comprise at least one three-dimensional graphics window and at least one two-dimensional graphics window; and
means for communicating to the plurality of render nodes information associated with only the at least one three-dimensional graphics window.
